(19) United States
(12) Patent Application Publication
(10) Pub. No.: US 2018/0374403 A1
(43) Pub. Date: Dec. 27, 2018

(54) Decorative Painting

(71) Applicant: Lei SUN, Zhejiang (CN)

(72) Inventor: Lei SUN, Zhejiang (CN)

(21) Appl. No.: 15/691,773

(22) Filed: Aug. 31, 2017

(30) Foreign Application Priority Data
Jun. 27, 2017 (CN) 201710496886.7

(51) Int. Cl. G09F 19/14; G09F 15/00

(52) U.S. Cl. CPC G09F 19/14; F16B 5/126; G09F 15/0006

(57) ABSTRACT

The present invention belongs to the filed of decorative painting technology and specifically involves a kind of decorative painting that can show different patterns according to the observers' different viewing locations and can present different pictures as required by changing the male tabs. It comprises a baseboard, a frame and the first groove which is equipped with 1-N male tabs. A male tab installing machine is provided in order to install male tabs. It comprises upper roller, nether roller, the first handle and the first bracket. A male tab filling machine is used for installation of the missing male tabs to make up the male tab installing machine's shortcoming. It comprises directing plate, roller, the third groove, the second handle and the second bracket.

### BACKGROUND OF THE INVENTION

The present invention belongs to the filed of decorative painting technology and in particular, relates to a kind of decorative painting that can show different patterns according to the observers' different viewing locations and can present different pictures as required by changing the male tabs.

Decorative paintings are unfailing as a featured product in interior wall decoration and outdoor advertisement. However, there are also several shortcomings: 1) The decorative paintings produced by the existing technology are mainly printed in planographic and plotted ways and one painting shows a picture which lacks stereoscopic impression. 2) The traditional form is not able to create a new viewing experience and it's difficult to satisfy the different aesthetic needs of consumers. 3) The back board of the existing decorative painting is susceptible to mold and deformation, which is not able to adapt to the special environment.

### BRIEF SUMMARY OF THE INVENTION

In allusion to the problems of existing technology, it is therefore an object of the present invention to design and provide a kind of decorative painting that can show different patterns according to the observers' different viewing location and can present different pictures as required by changing the male tabs. This decorative painting solves the problems of the existing decorative paintings such as single picture, high cost of changing paintings, lack of stereoscopic impression and so on.

The decorative painting comprising the baseboard and the frame, characterized in that the baseboard is equipped with 1-N the first grooves and there are 1-N male tabs in the removable set of the first groove.

The decorative painting, wherein the baseboard is a hollow slab which is produced by extrusion method. The materials of hollow slab can be PVC plastic, PP plastic, PE plastic and all kinds of nylon.

The decorative painting, wherein the baseboard has a bond and the 1-N baseboards can be jointed together successively by bonds in order to achieve the effect of arbitrary limits in baseboard width.

The decorative painting, wherein the bonds are jointed by glues or snap buttons.

The decorative painting, wherein there is a set of pattern on the front and back of the male tab and observers can see different patterns due to the different viewing location.

The decorative painting, wherein there is a set of pattern on the baseboard.

The decorative painting, wherein the patterns of the baseboards are printed directly on the baseboards.

The decorative painting, wherein the painted paper is glued to the baseboard and the painted paper covers the upper part of the first groove, which is cut a cutout by a cutter.

The decorative painting, wherein the cutout is undee.

The decorative painting, wherein there has adhesive to make sure that the male tabs are fastened in the first groove.

A male tab installing machine is used to install the decorative painting. Put the male tab into the baseboard, wherein it includes upper roller, nether roller, the first handle and the first bracket, wherein:

1.There is the second groove on the upper roller.

2.The spacing of the second groove is the same as the spacing of the first groove of the baseboard.

3.The upper roller can be freely adjusted leftwards and rightwards along the first bracket to align the first groove and the second groove.

4.The upper roller respectively has the first height adjustment screw and the second height adjustment screw on left and right sides. When installing male tab, one end of the baseboard would be pushed into the upper roller and the nether roller. Adjust the first height adjustment screw and the second height adjustment screw and the distance between the upper roller and the nether roller to make sure that the male tab completely fit in the bottom of the first groove and at the top of the second groove.

5.The first handle is linked with the nether roller.

A male tab filling machine is used for installation of the missing male tabs to make up the male tab installing machine's shortcoming. It is used to install the male tab to the baseboard,wherein it includes directing plate, roller, the third groove, the second handle and the second bracket, the directing plate can be fitted into the male tab which is inside of the first groove, the roller can slide freely on the baseboard and the third groove and the first groove can fix the male tab tightly.

The male tab filling machine as claimed, wherein the bottom of the third groove is cambered.

The pictures of the decorative paintings described above are rich and colorful and the painting update is convenient. The decorative painting can show different patterns according to the observers' different viewing location and can be applied to all kinds of complex environments by choosing the baseboard of corrosion resistant PVC and other materials.

The baseboard of the present invention produced in extrusion method can be manufactured in any length and can be jointed in any width by bonds. Therefore, baseboards of any size can be produced to satisfy the needs of home decoration and outdoor advertisement.

In order to install decorative paintings well, A male tab installing machine is invented to allow users to install the male tabs. In the meanwhile, it is inevitable that there are some male tabs wrongly installed or missed when using the male tab installing machine. In this case, male tab filling machines can be used to check and fill the leak.

### BRIEF DESCRIPTION OF THE DRAWINGS

FIG. 1 is a structural schematic diagram of the decorative paintings of the present invention.

FIG. 2 is a section view of A-A line in FIG. 1.

FIG. 3 is a structural schematic diagram of bonds of the present invention.

FIG. 4 is a local amplification schematic diagram of region C in FIG. 1.

FIG. 5 is a structural schematic diagram of male tab installing machine of the present invention.

FIG. 6 is a structural schematic diagram of male tab filling machine of the present invention.

FIG. 7 is the B perspective in FIG. 5.

Legends of the present invention:

1: baseboard; 2: male tab; 3: frame; 4: the first groove; 5: bond; 6: upper roller; 7: nether roller; 8: the first handle; 9: the first bracket; 10: the second groove; 11: the first height adjustment screw; 12: the second height adjustment screw; 13: directing plate; 14: roller; 15: the third groove; 16: the second handle; 17: the second bracket.

### DETAILED DESCRIPTION OF THE INVENTION

The present invention will be further illustrated below in combination with drawings of the description.

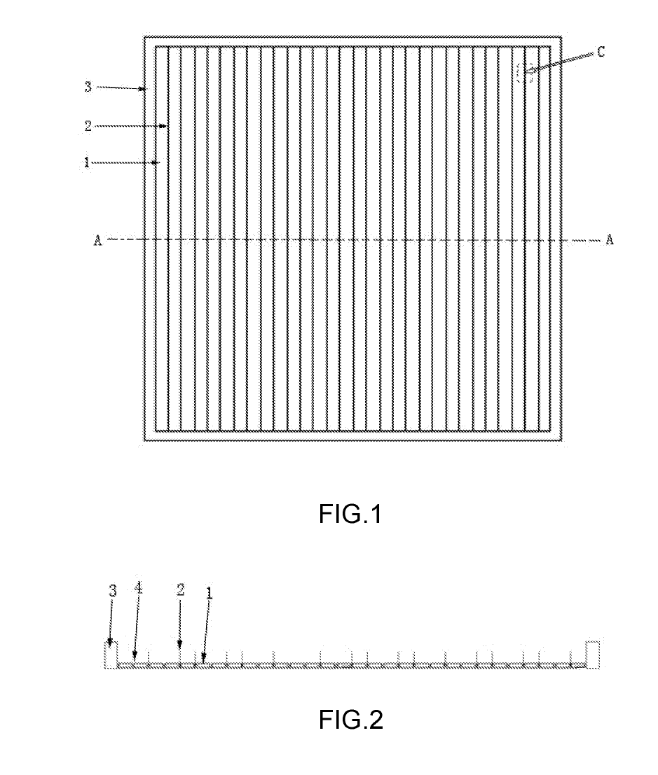

As shown in FIGS. 1 and 2, a decorative painting comprises baseboard 1 and frame 3, and the first groove 4 is on the baseboard and male tab 2 can be inserted in the first groove 4.

### EXAMPLE 1

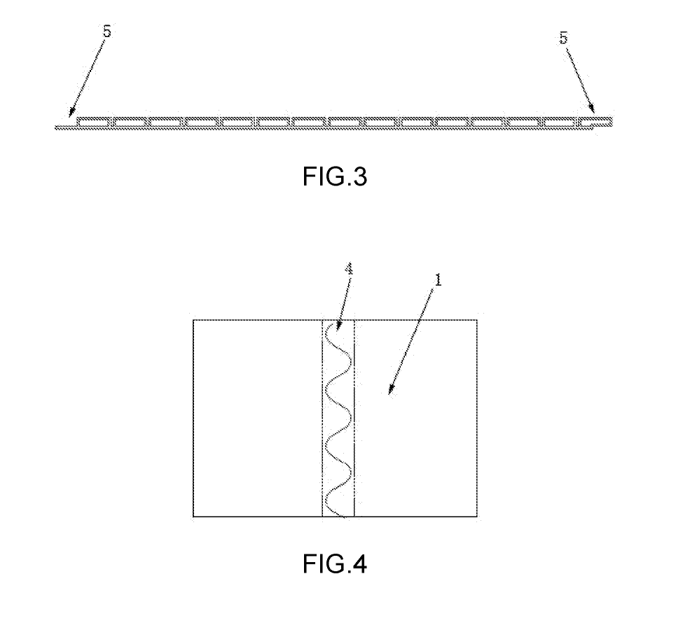

As shown in FIGS. 1, 2 and 3, the baseboard 1 of the decorative painting of the present invention is a hollow slab which is produced by extrusion method, and the length of the baseboard 1 can be set freely. The materials of hollow slab can be PVC plastic, PP plastic, PE plastic and all kinds of nylon. The baseboard 1 has a bond 5 and the 1-N baseboards 1 can be jointed together successively by bonds in order to achieve the effect of arbitrary limits in baseboard 1 width.

There is adhesive inside of the first groove 4 and the male tabs 2 are jointed by adhesive into the first groove 4. There is a set of pattern on the front and back of the male tab 2 and a set of patterns is printed on the baseboard 1 and observers can see different patterns due to the different viewing location. Observers can see the left pattern of the male tab 2 on the left side of the decorative painting, observers can see the pattern of the baseboard 1 when looking squarely at the decorative painting and observers can see the right pattern of male tab 2 on the right side of the decorative painting.

### EXAMPLE 2

As shown in FIGS. 1, 2, 3 and 4, the baseboard 1 of the decorative painting of the present invention is a hollow slab which is produced by extrusion method. The materials of hollow slab can be PVC plastic, PP plastic, PE plastic and all kinds of nylon. The baseboard 1 has a bond 5, and the 1-N baseboards 1 can be jointed together successively by bonds in order to achieve the effect of arbitrary limits in baseboard 1 width.

There is adhesive inside of the first groove 4 and the male tabs 2 are jointed by adhesive in the first groove 4.

There is a set of pattern on the front and back of the male tab 2, and paper with patterns covers the baseboard 1. The painted paper covers the upper part of the first groove 4, which is cut a undulate cutout by a cutter.

Observers can see different patterns due to the different viewing location. Observers can see the left pattern of male tab 2 on the left side of the decorative painting, observers can see the pattern on the baseboard 1 when looking squarely at the decorative painting and observers can see the right pattern of the male tab 2 on the right side of the decorative painting.

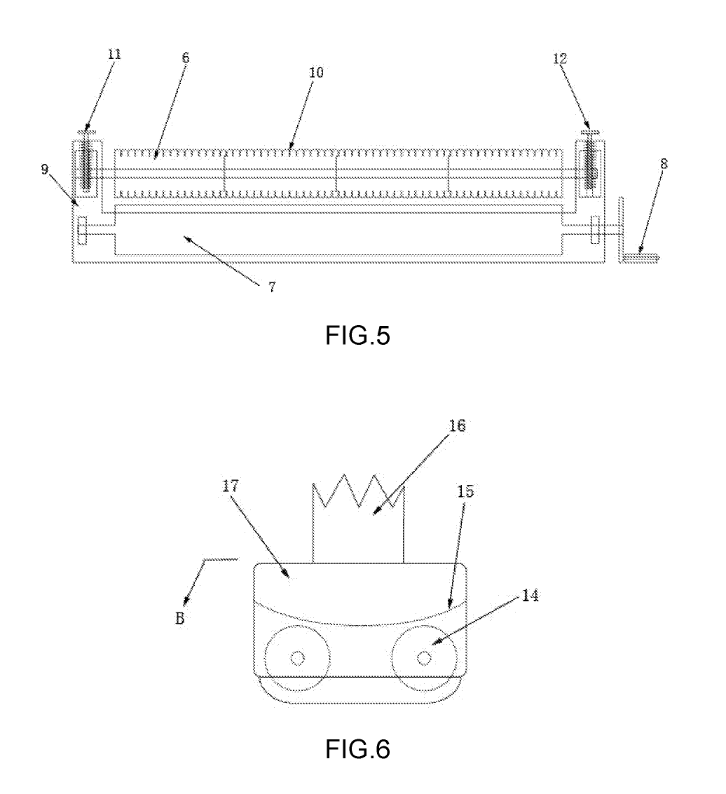

As shown in FIG. 5, A male tab installing machine includes upper roller 6, nether roller 7, the first handle 8 and the first bracket 9. There is the second groove 10 on the upper roller 6 which respectively has the first height adjustment screw 12 and the second height adjustment screw 13 on left and right sides.

### EXAMPLE 3

As shown in FIG. 5, a male tab installing machine comprises upper roller 6, nether roller 7, the first handle 8 and the first bracket 9 and there is the second groove 10 on the upper roller 6. The upper roller 6 can be freely adjusted leftwards and rightwards along the first bracket 9 to align the first groove 9 and the second groove 10 and it respectively has the first height adjustment screw 11 and the second height adjustment screw 12 on left and right sides.

When installing male tab 2, one end of the baseboard 1 would be pushed into the upper roller 6 and the nether roller 7. Adjust the first height adjustment screw 11 and the second height adjustment screw 12 and the distance between the upper roller 6 and the nether roller 7 to make sure that the male tab 2 completely fit in the bottom of the first groove 4 and at the top of the second groove 10. The first handle 8 is linked with the nether roller 7. Shake the first handle 8, and then the baseboard 1 can roll by following the nether roller 7 and insert the male tab 2.

As shown in FIG. 6, a male tab filling machine comprises directing plate 13, roller 14, the third groove 15, the second handles 16 and the second bracket 17. It is used for installation of the missing male tabs 2 to make up the male tab installing machine's shortcoming

### EXAMPLE 4

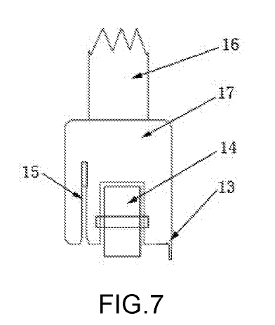

As shown in FIG. 6 and FIG. 7, a male tab filling machine comprises directing plate 13, roller 14, the third groove 15, the second handle 16 and the second bracket 17. The directing plate 13 can be fitted into the male tab 2 which is inside of the first groove 4, the roller 14 can slide freely on the baseboard 1 and the third groove 15 and the first groove 4 can fix the male tab 2 tightly.

The bottom of the third groove 15 is cambered.

The above mentioned and what is shown in the above figures are only preferred embodiments of the present invention. It should be pointed out by those skilled in the technology that various changes and improvements may be made therein without departing from the principle of the utility model, which should also be considered into the scope of the present invention's protection.

What is claimed is:

1. A decorative painting comprising a baseboard (1) and a frame (3), wherein the baseboard (1) is equipped with 1-N the first grooves (4), and there are 1-N male tabs (2) in the removable set of the first grooves (4).

2. A decorative painting according to claim 1, wherein the baseboard (1) is a hollow slab which is produced by extrusion method.

3. A decorative painting according to claim 1, wherein the baseboard (1) has a bond (5) and the 1-N baseboards (1) can be jointed together by bond (5).

4. A decorative painting according to claim 3, wherein the bonds (5) are jointed by glues or snap buttons.

5. A decorative painting according to claim 1, wherein there is a set of pattern on the front and back of the male tab (2) and observers can see different patterns due to the different viewing location.

6. A decorative painting according to claim 1, wherein there is a set of pattern on the baseboard (1).

7. A decorative painting according to claim 6, wherein the patterns of the baseboards (1) are printed directly on the baseboards (1).

8. A decorative painting according to claim 6, wherein the painted paper is glued to the baseboard (1), and the painted paper covers the upper part of the first groove (4) in baseboard (1), which is cut a cutout by a cutter and reveals the first groove (4) in order to insert male tabs (2).

9. A decorative painting according to claim 8, wherein the cutout is undee.

10. A decorative painting according to claim 1, wherein the first groove (4) has adhesive to make sure that the male tabs are fastened in it.

11. A male tab installing machine is used to install the male tab (2) to the baseboard (1) described in claim 1, wherein it includes upper roller (6), nether roller (7), the first handle (8) and the first bracket (9). wherein:
1).There are the second grooves (10) on the upper roller (6).
2).The spacing of the second groove (10) is the same as the spacing of the first groove (4) of the baseboard (1).
3).The upper roller (6) can be freely adjusted leftwards and rightwards along the first bracket (9) to align the first groove (4) and the second groove (10).
4).The upper roller (6) respectively has the first height adjustment screw (11) and the second height adjustment screw (12) on left and right sides. When installing male tab (2), one end of the baseboard (1) would be pushed into the upper roller (6) and the nether roller (7). Adjust the first height adjustment screw (11) and the second height adjustment screw (12) and the distance between the upper roller (6) and the nether roller (7) to make sure that the male tab (2) completely fit in the bottom of the first groove (4) and at the top of the second groove (10).
The first handle (8) is linked with the nether roller (7).

12. A male tab filling machine is used to install the male tab (2) to the baseboard (1) as claimed in claim 1, wherein it includes directing plate (13), roller (14), the third groove (15), the second handle (16) and the second bracket (17). The directing plate (13) can be fitted into the male tab (2) which is inside of the first groove (4).

13. A male tab filling machine according to claim12, wherein the bottom of the third groove (15) is cambered.
